(19) United States
(12) Patent Application Publication
(10) Pub. No.: US 2014/0159263 A1
(43) Pub. Date: Jun. 12, 2014

(54) PORTABLE APPARATUSES AND METHODS FOR THE PRODUCTION OF MICROFIBERS AND NANOFIBERS

(71) Applicants: Karen Lozano, Edinburg, TX (US); Simon Padron, Edinburg, TX (US); Javier Ortega, Pharr, TX (US)

(72) Inventors: Karen Lozano, Edinburg, TX (US); Simon Padron, Edinburg, TX (US); Javier Ortega, Pharr, TX (US)

(21) Appl. No.: 14/096,811

(22) Filed: Dec. 4, 2013

Related U.S. Application Data
(60) Provisional application No. 61/733,296, filed on Dec. 4, 2012.

(51) Int. Cl. D01D 5/18; B29C 47/00

(52) U.S. Cl. CPC D01D 5/18; B29C 47/0002
USPC 264/8; 425/8

(57) ABSTRACT

Described herein are apparatuses and methods of creating fibers, such as microfibers and nanofibers. The methods discussed herein employ centrifugal forces to transform material into fibers. Apparatuses that may be used to create fibers are also described.

### PRIORITY CLAIM

This application claims priority to U.S. Provisional Application Ser. No. 61/733,296 entitled “APPARATUSES AND METHODS FOR THE PRODUCTION OF MICROFIBERS AND NANOFIBERS ” filed Dec. 4, 2013.

### STATEMENT REGARDING FEDERALLY SPONSORED RESEARCH OR DEVELOPMENT

This invention was made with government support from the National Science Foundation (NSF), Grant number 41EMEC022. The U.S. Government has certain rights to this invention.

### BACKGROUND OF THE INVENTION

1. Field of the Invention

The present invention generally relates to the field of fiber production. More specifically, the invention relates to production of fibers of micron, sub-micron and nano size diameters using centrifugal forces within a portable device.

2. Description of the Relevant Art

Fibers having small diameters (e.g., micrometer (“micron”) to nanometer (“nano”)) are useful in a variety of fields from the clothing industry to military applications. For example, in the biomedical field, there is a strong interest in developing structures based on nanofibers that provide scaffolding for tissue growth to effectively support living cells and as agents in wound care such as inducing haemostasis, protecting against infection, accelerating the healing process while offering conformability (e.g., ability to adapt to 3D intricate sections). In the textile field, there is a strong interest in nanofibers because the nanofibers have a high surface area per unit mass that provide light, but highly wear resistant, garments. As a class, carbon nanofibers are being used, for example, in reinforced composites, in heat management, and in reinforcement of elastomers. Many potential applications for small-diameter fibers are being developed as the ability to manufacture and control their chemical and physical properties improves.

It is well known in fiber manufacturing to produce micro and nano fibers of various materials by electrospinning The process of elecrospinning uses an electrical charge to produce fibers from a liquid. The liquid may be a solution of a material in a suitable solvent, or a melt of the material. Electrospinning requires the use of high voltage to draw out the fibers and is limited to materials that can obtain an electrical charge.

Centrifugal spinning is a method by which fibers are produced without the use of an electric field. In centrifugal spinning, material is ejected through one or more orifices of a rapidly spinning spinneret to produce fibers. The size and or shape of the orifice that the material is ejected from controls the size of the fibers produced. Using centrifugal spinning, microfibers and/or nanofibers may be produced.

Typically, spinnerets used in centrifugal spinning are rotated at high speeds. The high rotational speed used to form the fibers creates high energy requirements, due to rotational air resistance at high speeds. It is desirable to create spinnerets that have reduced air resistance to minimize energy requirements. Additionally, spinnerets generally produce fibers in a single plane, which causes fiber entanglement. It would therefore be desirable to create spinnerets that can create fibers in a way that avoids entanglement of the fibers that can maximize yield and enhance uniform fiber deposition if desired, and are easily cleaned.

### SUMMARY OF THE INVENTION

In an embodiment, a hand held/portable device for the production of microfibers and/or nanofibers includes: one or more motors, a fan coupled to at least one of the one or more motors; and a spinneret comprising a body and one or more openings, the spinneret being coupled to at least one of the one or more motors, wherein the fan and spinneret are, during use, rotated substantially simultaneously. During use, rotation of the spinneret causes material placed in the body of the spinneret to be ejected through one or more of the openings to produce fibers. The fan is positioned with respect to the spinneret such that the fibers produced by the spinneret are blow away from the spinneret by the gas flow produced by the rotating fan. In an embodiment, the device also includes a material reservoir coupled to the body of the spinneret, wherein material disposed in the material reservoir is transferred to the spinneret body during use. The spinneret may be removably coupled to at least one motor through a coupling member.

The components of the device, for example, the motor, fan and spinneret, may be placed in a molded housing. The molded housing may include a handle. The molded housing may include a tapered outlet, wherein fibers produced by the spinneret are blow away from the spinneret into the tapered outlet. In an embodiment, the fan, the motor, and the spinneret may be aligned along an axial axis of the molded housing.

In an embodiment, the fan and spinneret are positioned on opposing sides of the one or more motors. The device may include a first motor coupled to the fan and a second motor coupled to the spinneret. The first motor may rotate the fan at a different speed than the second motor rotates the spinneret during use.

In an embodiment, the spinneret comprises a plurality of outlet elements coupled to the body, wherein one or more openings are formed in the outlet elements, extending through the outlet elements to the body, wherein during use, material in the body passes through the openings formed in the outlet elements. In an embodiment, the spinneret further comprises one or more pellets positioned in the one or more openings, wherein the pellets inhibit the ejection of material from the one or more outlet elements unless the spinneret is rotating. In an embodiment, the device further includes a channeling chamber coupled to the housing, wherein the channeling chamber directs the fibers exiting the fiber producing device during use. The channeling chamber may be coupled to the housing by a hinge, wherein the hinge is configured to allow the channeling chamber to be moved away from the housing during use.

In an embodiment, a method of producing microfibers and/or nanofibers, includes: placing material in a spinneret as described above; rotating the spinneret at a speed of at least about 1000 rpm, and, substantially simultaneously rotating the fan, wherein rotation of the spinneret causes material in the body to be ejected through one or more openings to produce fibers; and wherein the fibers produced by the spinneret are blow away from the spinneret by the gas flow produced by the rotating fan. In an embodiment, the microfibers and/or nanofibers are created without subjecting the fibers, during their creation, to an externally applied electric field.

In one embodiment, the method includes heating the material to a temperature sufficient to at least partially melt the material; and placing the heated material in the body of the spinneret. In another embodiment, the method includes mixing the material with a solvent to produce a mixture of the material in a solvent, and placing the mixture in the body of the spinneret.

The device described herein may be used to apply fibers to a wound. In an embodiment, the method includes directing the fibers produced by the device toward a wound site of a subject. The fibers may be directed toward the wound site for a time sufficient to form a substantial wound dressing over the wound. In an embodiment, a mesh-like material may be applied to a wound site, and the produced fibers may be directed toward the mesh-like material on the wound site. In an embodiment, the material is a polymer capable of accelerating wound healing. The polymer may be a polymer that promotes hemostasis.

In an embodiment, a kit for treating wounds includes: a hand-held fiber producing device as described above and one or more compositions comprising a polymer disposed in a solvent.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts an embodiment of a fiber producing device;

FIG. 2 depicts a schematic diagram of a fiber producing device during use;

FIG. 3 depicts an embodiment of panels formed on an interior surface of a housing of a fiber producing device;

FIG. 4 depicts an embodiment of a spinneret;

FIGS. 5A-C depicts a material reservoir coupled to a spinneret;

FIG. 6 depicts an embodiment of a fan;

FIG. 7 depicts an embodiment of a fiber producing device having a channeling chamber coupled to the housing;

FIG. 8 depicts non-limiting embodiments of channeling chambers that may be used to direct fibers produced by the fiber producing device;

FIG. 9 depicts various spinneret designs; and

FIG. 10 depicts various spinnerets (bottom and side views) having outlet elements.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a method or apparatus that “comprises,” “has,” “includes” or “contains” one or more steps or elements possesses those one or more steps or elements, but is not limited to possessing only those one or more steps or elements. Likewise, an element of an apparatus that “comprises,” “has,” “includes” or “contains” one or more features possesses those one or more features, but is not limited to possessing only those one or more features.

Described herein are apparatuses and methods of creating fibers, such as microfibers and nanofibers. The methods discussed herein employ centrifugal forces to transform material into fibers. Apparatuses that may be used to create fibers are also described. Some details regarding creating fibers using centrifugal forces may be found in the following U.S. Published Patent Applications: 2009/0280325 entitled “Methods and Apparatuses for Making Superfine Fibers” to Lozano et al.; 2009/0269429 entitled “Superfine Fiber Creating Spinneret and Uses Thereof” to Lozano et al.; and 2009/0280207 entitled “Superfine Fiber Creating Spinneret and Uses Thereof” to Lozano et al., and U.S. Pat. No. 8,231,378 entitled “Superfine Fiber Creating Spinneret and Uses Thereof” all of which are incorporated herein by reference.

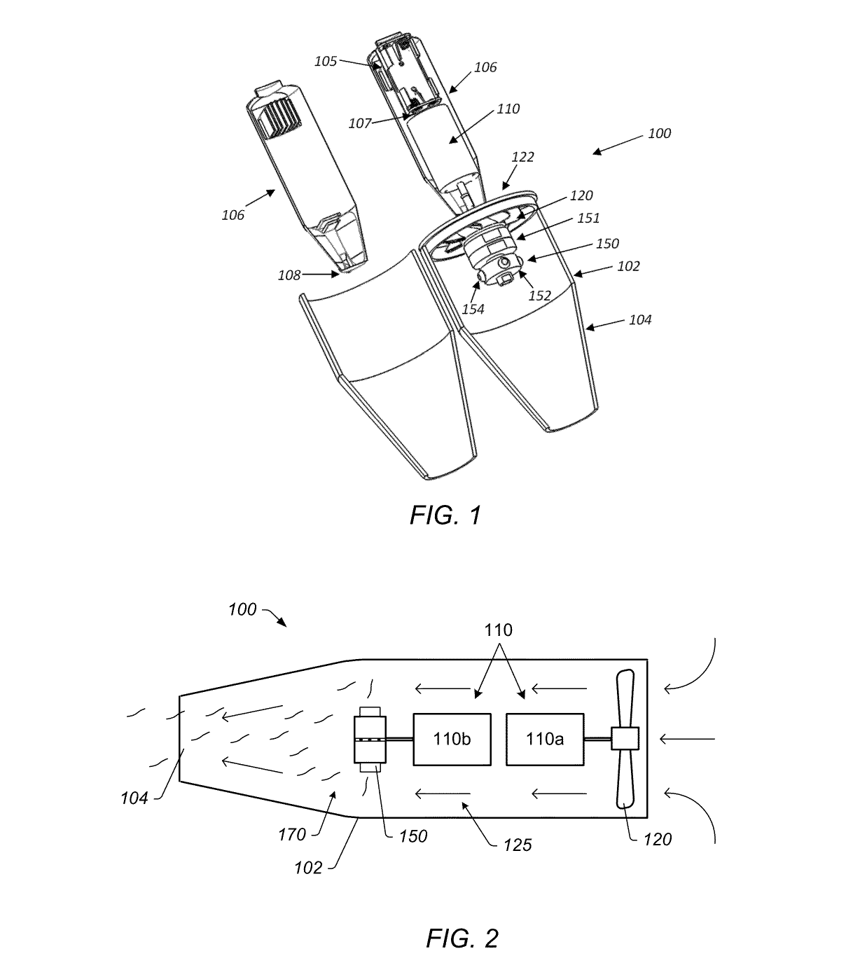

FIG. 1 depicts a schematic diagram of a fiber producing system 100. Fiber producing system 100 includes one or more motors 110 coupled to a fan 120, a material reservoir 151, and a spinneret 150. Spinneret 150 includes a body 152 having one or more openings 154. During use, rotation of the spinneret causes material placed in the body of the spinneret to be ejected through one or more of the openings to form fibers. Fiber producing system 100 includes an outer housing 102 which at least partially contains fan 120, material reservoir 151, spinneret 150, and motors 110. A filter 122 may be placed at the inlet end of housing 102 to filter dust and debris from the gas (e.g., air) being pulled into the system by fan 120.

In an embodiment, the spinneret 150 could be a disposable cartridge that is removable and linkable to one or more motors 110. In an embodiment, the spinneret 150 may include an inlet 153 that receives material to be spun into fibers. The fiber producing system 100 may include a material reservoir 151, disposed within spinneret 150, to store the material to be spun. A conduit 157 couples material reservoir 151 to inlet 153 of the spinneret to allow material to be transferred from material reservoir 151 to the spinneret during use. In some embodiments, material reservoir 151 is a cartridge that is removably coupled to spinneret 150. The use of a material reservoir cartridge allows replenishment of the material without any significant disassembly of the device.

In some instances, housing 102 may be designed for hand held usage. Housing 102 may have a size and shape that allows the fiber producing system to be portable. For example, housing 102 may have a shape similar to a hair dryer or a rotary tool. In an embodiment, housing 102 includes handle 106. Handle 106 may be positioned to allow a user to hold the fiber producing system so that the fiber producing system can be aimed at the region that the fibers are needed. Thus a user may be able to selectively direct fibers to a surface of interest. Handle 106 may include a switch 108 (e.g., a trigger switch) which can be used to operate the fiber producing system. In an embodiment, operation of switch 108 causes the fan and spinneret to begin spinning, producing an outward flow of fibers from outlet 104 of the housing. In order to improve portability of the device, fiber producing system 100 may have an internal power source 105 (e.g., a battery). Internal power source 105 may be coupled to motors 110 and switch 108 via wiring 107 disposed inside housing 102. Internal power source may also include an adapter which allows the fiber producing device to be plugged into an external outlet. If the internal power source is a rechargeable battery, plugging the fiber producing device into an external outlet provides power to operate the fiber producing device and recharge the battery.

In some embodiments, two or more switches may be used to control the operation of the fiber producing system. In an embodiment, one switch may be used to operate the spinneret motor, while a second switch may be used to operate the fan. Having independent fan and spinneret switches may allow a user to control air supply as needed for fiber size, quality, deposition and/or ultimate applications required where outgoing air stream could be detrimental. Switches used to control the spinneret motor and/or the fan motor may be on/off switches, or may provide variable speed control for the attached motor. For example, a fan motor switch may allow the user to vary the speed of the fan motor to optimize the fan speed. Similarly, the spinneret motor may be coupled to a variable speed control switch which allows the user to vary the speed of the spinneret. A variable speed switch may allow continuous adjustment of the speed (i.e., varying the speed at any value between 1% to 100% the maximum speed of the motor) or discrete adjustment of the speed (e.g., preselected values such as low (20% of max speed), medium (50% of max speed), and high (100% of max speed).

FIG. 2 depicts a schematic diagram of fiber producing system 100 in operation. During use of fiber producing system 100, fan 120 and spinneret 150 are substantially simultaneously operated (e.g., rotated) in the vertical position. Rotation of spinneret 150 causes fibers 170 to be produced. Fibers 170 are ejected from spinneret 150 and are dispersed within fiber producing system 100. Rotation of fan 120 produces a fluid flow of gas 125 (e.g., air) toward the spinneret 150. The produced fibers 170 are captured in the gas flow and are forced toward an outlet end 104 of housing 102.

In an embodiment, housing 102 may have a tapered outlet 104. During use, fibers produced by spinneret 150 may be blow away from the spinneret into the tapered outlet 104. In an embodiment, tapered outlet 104 may be in the form of a channeling chamber (e.g., a funnel) coupled to the housing 102.

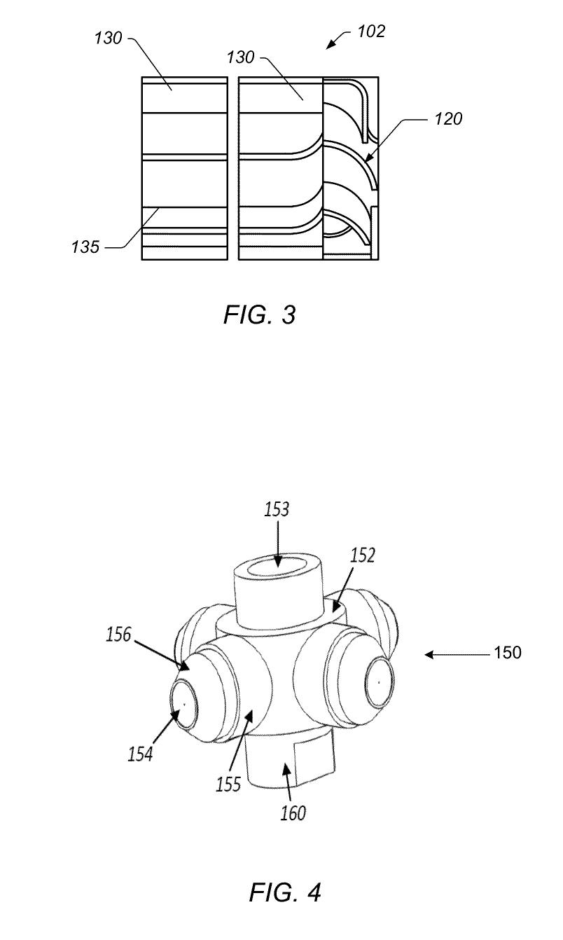

To improve the air flow through the device, the inner surface of housing 102 may include one or more panels 130 that include guiding channels that direct air flow through the housing. FIG. 3 depicts an embodiment of two panels 130 formed on an interior surface of housing 102. Panel 130 includes a plurality of vents 135 formed in the panel that direct air flow from fan 120 through housing 102. In this manner, gas flow from the fan is directed to the fibers as the fibers are being produced. Vents 135 within the casing direct the air flow produced by the fan perpendicularly to the rotating spinneret and remove the vorticity of the air flow caused by the rotating fan.

FIG. 4 depicts an embodiment of a spinneret 150. Spinneret 150 may include an inlet 153 that receives material to be spun into fibers. Spinneret 150 includes a plurality of outlet elements 155, coupled to body 152. Outlet elements 155 may include at least one nozzle 156 which include one or more openings 154. Openings 154 extend through outlet element 155 into a reservoir that is defined within body 152. Furthermore, openings 154 may include a pellet or spherical body used as a valve allowing the material to be ejected through the openings only by action of centrifugal forces when the spinneret is rotating. Moreover, the pellet valve is able to block the entrance of foreign objects through the openings when the spinneret is not rotating.

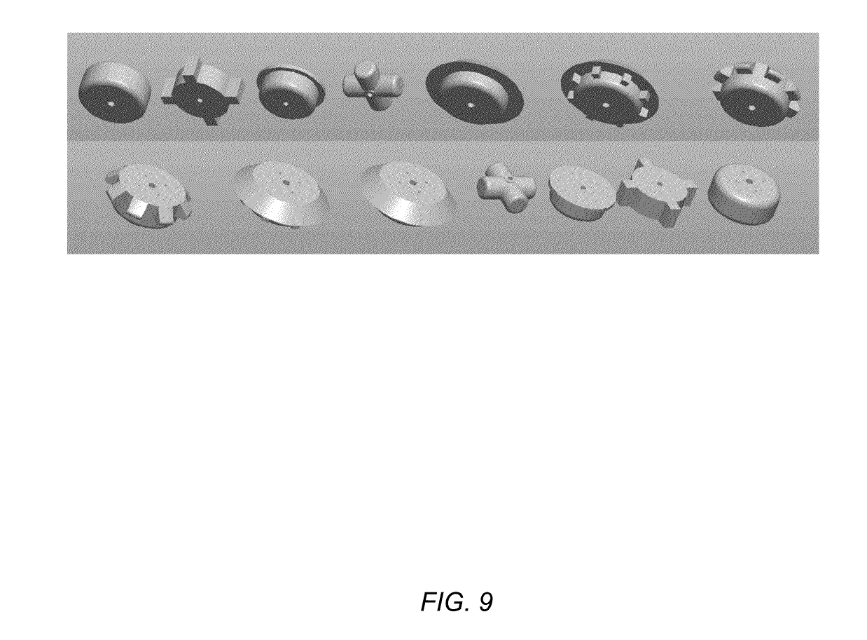

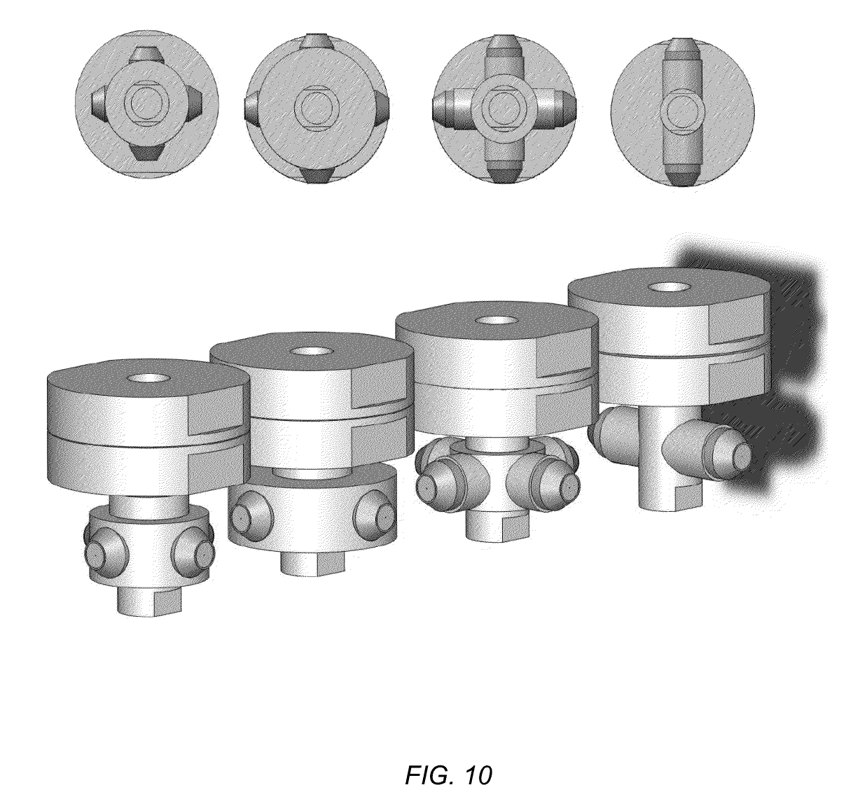

Alternate, non-limiting, spinneret designs are depicted in FIG. 9. A spinneret may also be designed to work within the high axial air flow by having a barrier. The barrier blocks the gas flowing from the fan close to the openings of the spinneret, allowing the emerging jets to travel in the radial direction initially before being redirected in the axial direction by the gas. Examples of spinnerets that include this barrier are depicted in FIG. 9 (top row, 3rd, 5th, 6th, and 7^{th} from the left). The use of such a barrier solves the problem that, during high axial gas flows, the fibers are sometimes sheared from the surface of the orifice instead of producing a jet. Specialized spinneret designs, as depicted in FIG. 9, can be used to control fiber formation under a confined air flow that is directed perpendicularly to the rotating spinneret. In some embodiments, spinnerets include multiple openings (e.g., at least more than two openings) to improve the throughput of fiber production. Various embodiments of spinnerets having outlet elements are depicted in FIG. 10.

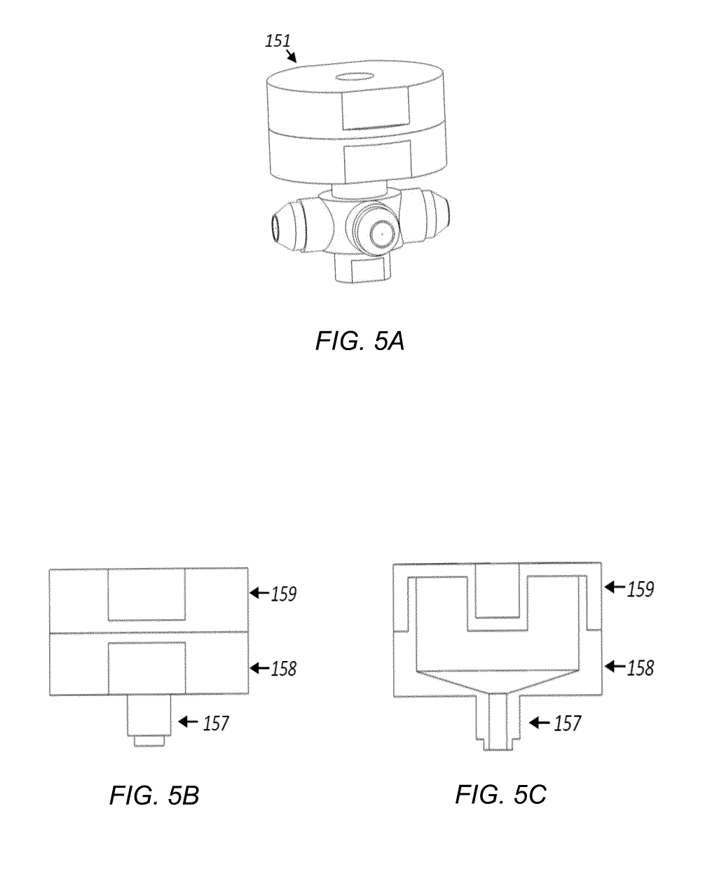

FIGS. 5A-C depict an embodiment of a material reservoir 151 coupled to a spinneret. The material reservoir may include a concave cavity 158 and a lid 159 positioned above the concave cavity. Material reservoir 151 includes one or more openings or conduits 157 in communication with the concave cavity 158 to allow the material to flow from the material reservoir to the spinneret body 152.

In an embodiment, a heating element may be incorporated in the housing and/or spinneret to allow heating of the spinneret. Use of a heating element may be particularly useful for melt spinning of fibers.

During use, material in body 152, passes from the body into the openings 154 and is ejected through the openings when the spinneret is rotated. Spinneret 150 may include a coupling member 160, which can be used to removably couple the spinneret to motor 110.

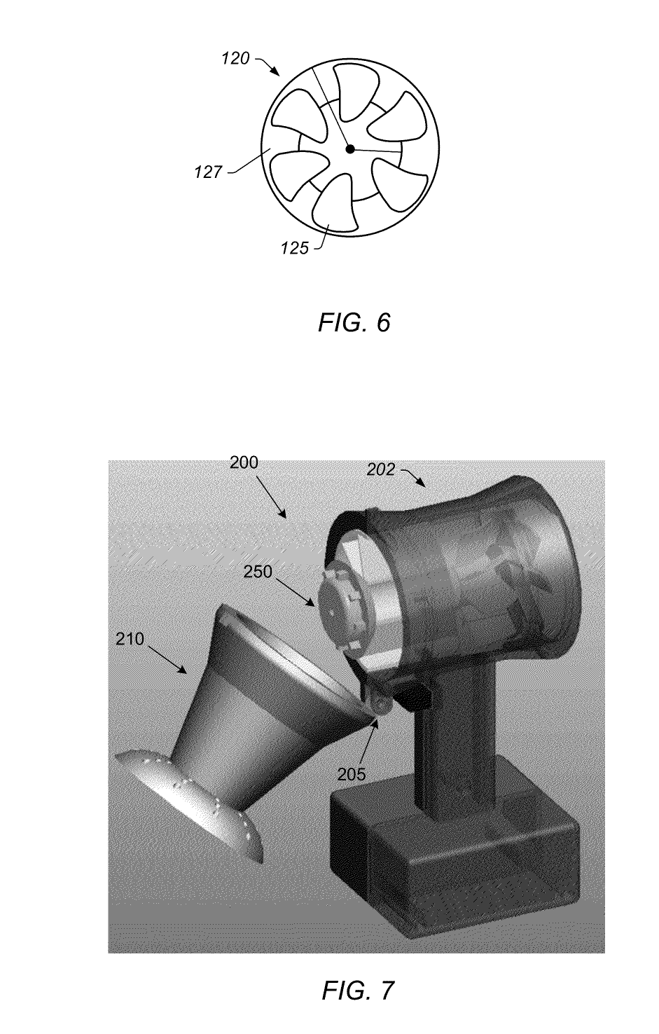

FIG. 6 depicts an embodiment of fan 120. Fan 120 may include a plurality of fan blades 125 coupled to a rotating base 127. During use, the rotating base 127 is coupled to motor 110 and rotated to produce a gas flow. Fan blades 125 may be angled to produce a gas flow that is directed toward spinneret 150.

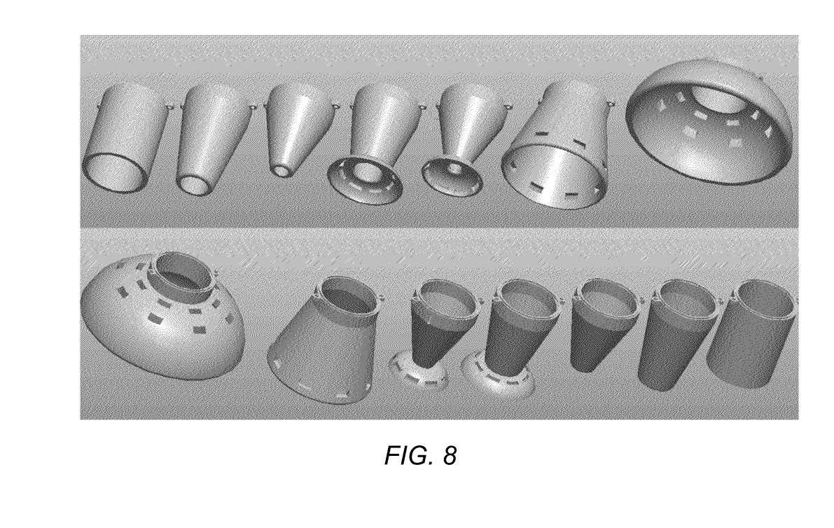

FIG. 7 depicts an embodiment of a fiber producing device 200 having a channeling chamber 210 coupled to housing 202. In an embodiment, channeling chamber 210 may be coupled to housing 202 through a hinge 205. Hinge 205 allows the channeling chamber to be removed from the housing, allowing replacement of a disposable cartridge spinneret 250, and general cleaning of the interior of the fiber producing device. In some embodiments, channeling chamber may also be removable allowing alternate channeling chambers to be attached to the housing.

FIG. 8 depicts non-limiting embodiments of channeling chambers that may be used to direct fibers produced by the fiber producing device, for different fiber deposition applications. Certain channeling chambers may be used for deposition on hard surfaces while others may be used to cover a certain specific area, such as wounds. Different channeling chambers may be used to control the air currents. The hinge design of the channeling chamber allows simple cleaning of the device by having the areas exposed to the produced fibers (the channeling chamber and the spinneret) easily removable for cleaning and/or for exchange.

In an embodiment, fan 120, motors 110, material reservoir 151, and spinneret 150 are substantially aligned along an axial axis of the motor. In this manner, the gas flow produced by fan 120 flows past motors 110, providing a cooling effect for the motors. The gas flow produced by fan 120 then flows to spinneret 150, where the produced fibers are caught by the flowing gas and directed to the housing outlet 104. In some embodiments, the fan 120, motors 110 and spinneret 150 are substantially aligned along an axial axis of the housing. In an embodiment, fan 120 and spinneret 150 are disposed on opposing sides of motors 110. This configuration allows motors 110 to individually drive fan 120 (with motor 110a) and spinneret 150 (with motor 110b), thus allowing each part to be driven at different rates. For example, the spinneret, in some embodiments, is rotated at a much faster rate than the fan. In these embodiments, the use of two motors is useful in implementing this process.

The fiber production device described above uses rotating and aerodynamic forces (e.g., the gas flow produced by the fan) to produce and control fiber deposition. In some embodiments, the housing includes all necessary components to produce fibers, and has a size and shape that allows the device to be hand-held. The fiber producing device relies on centrifugal spinning to create fibers as the material is ejected from the spinneret. Thus, no external electric field is required, or used, to create fibers.

Fibers represent a class of materials that are continuous filaments or that are in discrete elongated pieces, similar to lengths of thread. Fibers are of great importance in the biology of both plants and animals, e.g., for holding tissues together. Human uses for fibers are diverse. For example, fibers may be spun into filaments, thread, string, or rope. Fibers may also be used as a component of composite materials. Fibers may also be matted into sheets to make products such as paper or felt. Fibers are often used in the manufacture of other materials.

Fibers as discussed herein may be created using, for example, a solution spinning method or a melt spinning method. In both the melt and solution spinning methods, a material may be put into a spinneret which is spun at various speeds until fibers of appropriate dimensions are made. The material may be formed, for example, by melting a solute or may be a solution formed by dissolving a mixture of a solute and a solvent. Any solution or melt familiar to those of ordinary skill in the art may be employed. For solution spinning, a material may be designed to achieve a desired viscosity, or a surfactant may be added to improve flow, or a plasticizer may be added to soften a rigid fiber. In melt spinning, solid particles may comprise, for example, a metal or a polymer, wherein polymer additives may be combined with the latter. Certain materials may be added for alloying purposes (e.g., metals) or adding value (such as antioxidant or colorant properties) to the desired fibers.

Non-limiting examples of reagents that may be melted, or dissolved or combined with a solvent to form a material for melt or solution spinning methods include polyolefin, polyacetal, polyamide, polyester, cellulose ether and ester, polyalkylene sulfide, polyarylene oxide, polysulfone, modified polysulfone polymers and mixtures thereof. Non-limiting examples of solvents that may be used include oils, lipids and organic solvents such as DMSO, toluene and alcohols. Water, such as de-ionized water, may also be used as a solvent. For safety purposes, non-flammable solvents are preferred.

In either the solution or melt spinning method, as the material is ejected from the spinning spinneret, thin jets of the material are simultaneously stretched and dried or stretched and cooled in the surrounding environment. Interactions between the material and the environment at a high strain rate (due to stretching) leads to solidification of the material into fibers, which may be accompanied by evaporation of solvent. By manipulating the temperature and strain rate, the viscosity of the material may be controlled to manipulate the size and morphology of the fibers that are created. A wide variety of fibers may be created using the present methods, including novel fibers such as polypropylene (PP) nanofibers. Non-limiting examples of fibers made using the melt spinning method include polypropylene, acrylonitrile butadiene styrene (ABS) and nylon. Non-limiting examples of fibers made using the solution spinning method include polyethylene oxide (PEO) and beta-lactams.

The methods discussed herein may be used to create, for example, nanocomposites and functionally graded materials that can be used for fields as diverse as, for example, drug delivery, wound healing, and ultrafiltration (such as electrets). Metallic and ceramic nanofibers, for example, may be manufactured by controlling various parameters, such as material selection and temperature. At a minimum, the methods and apparatuses discussed herein may find application in any industry that utilizes micro- to nano-sized fibers and/or micro- to nano-sized composites. Such industries include, but are not limited to, material engineering, mechanical engineering, military/defense industries, biotechnology, medical devices, tissue engineering industries, food engineering, drug delivery, electrical industries, or in ultrafiltration and/or micro-electric mechanical systems (MEMS).

Some embodiments of a spinneret may be used for melt and/or solution processes. Some embodiments of a spinneret may be used for making organic and/or inorganic fibers. With appropriate manipulation of the environment and process, it is possible to form fibers of various configurations, such as continuous, discontinuous, mat, random fibers, unidirectional fibers, woven and nonwoven, as well as fiber shapes, such as circular, elliptical and rectangular (e.g., ribbon). Other shapes are also possible. The produced fibers may be single lumen or multi-lumen.

By controlling the process parameters, fibers can be made in micron, sub-micron and nano-sizes, and combinations thereof. In general, the fibers created will have a relatively narrow distribution of fiber diameters. Some variation in diameter and cross-sectional configuration may occur along the length of individual fibers and between fibers.

Generally speaking, a spinneret helps control various properties of the fibers, such as the cross-sectional shape and diameter size of the fibers. More particularly, the speed and temperature of a spinneret, as well as the cross-sectional shape, diameter size and angle of the outlets in a spinneret, all may help control the cross-sectional shape and diameter size of the fibers. Lengths of fibers produced may also be influenced by the choice of spinneret used.

The temperature of the spinneret may influence fiber properties, in certain embodiments. Both resistance and inductance heaters may be used as heat sources to heat the spinneret. In certain embodiments, the spinneret is thermally coupled to a heat source that may be used to adjust the temperature of the spinneret before spinning, during spinning, or both before spinning and during spinning In some embodiments, the spinneret is cooled. For example, a spinneret may be thermally coupled to a cooling source that can be used to adjust the temperature of the spinneret before spinning, during spinning, or before and during spinning Temperatures of a spinneret may range widely. For example, a spinneret may be cooled to as low as −20C or heated to as high as 2500 C. Temperatures below and above these exemplary values are also possible. In certain embodiments, the temperature of a spinneret before and/or during spinning is between about 4° C. and about 400° C. The temperature of a spinneret may be measured by using, for example, an infrared thermometer or a thermocouple.

The speed at which a spinneret is spun may also influence fiber properties. The speed of the spinneret may be fixed while the spinneret is spinning, or may be adjusted while the spinneret is spinning A spinneret whose speed may be adjusted may, in certain embodiments, be characterized as variable speed spinneret. In the methods described herein, the spinneret may be spun at a speed of about 500 RPM to about 15,000 RPM, or any range derivable therein. In certain embodiments, the spinneret is rotated at a rate of about 5,000 RPM to about 15,000 RPM.

In an embodiment, a method of creating fibers, such as microfibers and/or nanofibers, includes: heating a material; placing the material in a heated spinneret; and, after placing the heated material in the heated spinneret, rotating the spinneret to eject material to create nanofibers from the material. In some embodiments, the fibers may be microfibers and/or nanofibers. A heated spinneret is a structure that has a temperature that is greater than ambient temperature. “Heating a material” is defined as raising the temperature of that material to a temperature above ambient temperature. “Melting a material” is defined herein as raising the temperature of the material to a temperature greater than the melting point of the material, or, for polymeric materials, raising the temperature above the glass transition temperature for the polymeric material. In alternate embodiments, the spinneret is not heated. Indeed, for any embodiment that employs a spinneret that may be heated, the spinneret may be used without heating. In some embodiments, the spinneret is heated but the material is not heated. The material becomes heated once placed in contact with the heated spinneret. In some embodiments, the material is heated and the spinneret is not heated. The spinneret becomes heated once it comes into contact with the heated material.

A wide range of volumes/amounts of material may be used to produce fibers. In addition, a wide range of rotation times may also be employed. For example, in certain embodiments, at least 5 milliliters (mL) of material are positioned in a material reservoir coupled to a spinneret, and the spinneret is rotated for at least about 10 seconds. As discussed above, the rotation may be at a rate of about 500 RPM to about 25,000 RPM, for example. The amount of material may range from mL to liters (L), or any range derivable therein. For example, in certain embodiments, at least about 50 mL to about 100 mL of the material are positioned in the spinneret body or a material reservoir coupled to the spinneret body, and the spinneret is rotated at a rate of about 500 RPM to about 25,000 RPM for about 300 seconds to about 2,000 seconds.

In certain embodiments, at least about 5 mL to about 100 mL of the material are positioned in the spinneret body or a material reservoir coupled to the spinneret body, and the spinneret is rotated at a rate of 500 RPM to about 25,000 RPM for 10-500 seconds. In certain embodiments, at least 100 mL to about 1,000 mL of material is positioned in the spinneret body or a material reservoir coupled to the spinneret body, and the spinneret is rotated at a rate of 500 RPM to about 25,000 RPM for about 100 seconds to about 5,000 seconds. Other combinations of amounts of material, RPMs and seconds are contemplated as well.

Typical dimensions for spinneret are in the range of about 0.1 inches to several inches in diameter and in height. In some embodiments, a spinneret has a diameter of between about 0.25 inch to about 1 inch.

In certain embodiments, the spinneret includes multiple openings and the material is extruded through the multiple openings to create the nanofibers. These openings may be of a variety of shapes (e.g., circular, elliptical, rectangular, square) and of a variety of diameter sizes (e.g., 0.01-0.80 mm). When multiple openings are employed, not every opening needs to be identical to another opening, but in certain embodiments, every opening is of the same configuration. Some openings may include a divider that seperates the material, as the material passes through the openings. The divided material may form multi-lumen fibers. As discussed previously, openings may include a pellet or spherical body used as a valve allowing the material to be ejected through the openings by action of centrifugal forces when the spinneret is rotating. Furthermore the pellet valve is able to block the entrance of foreign objects through the openings when the spinneret is not rotating.

In an embodiment, material may be positioned in a body of a spinneret or a material reservoir coupled to a spinneret. The body may, for example, have a concave cavity. In certain embodiments, the body includes one or more openings in communication with the concave cavity. The fibers are extruded through the one or more openings while the spinneret is rotated about a spin axis. The one or more openings have an opening axis that is not parallel with the spin axis. The spinneret may include a body that includes the concave cavity and a lid positioned above the body.

Another spinneret variable includes the material(s) used to make the spinneret. Spinnerets may be made of a variety of materials, including metals (e.g., brass, aluminum, stainless steel) and/or polymers. The choice of material depends on, for example, the temperature the material is to be heated to, or whether sterile conditions are desired.

The material employed may include one or more components. The material may be of a single phase (e.g., solid or liquid) or a mixture of phases (e.g., solid particles in a liquid). In some embodiments, the material includes a solid and the material is heated. The material may become a liquid upon heating. In another embodiment, the material may be mixed with a solvent. As used herein a “solvent” is a liquid that at least partially dissolves the material. Examples of solvents include, but are not limited to, water and organic solvents. Examples of organic solvents include, but are not limited to: hexanes, ether, ethyl acetate, acetone, dichloromethane, chloroform, toluene, xylenes, petroleum ether, dimethylsulfoxide, dimethylformamide, or mixtures thereof. Additives may also be present. Examples of additives include, but are not limited to: thinners, surfactants, plasticizers, or combinations thereof.

The material used to form the fibers may include at least one polymer. Polymers that may be used include conjugated polymers, biopolymers (wound care applications), water soluble polymers, and particle infused polymers. Examples of polymers that may be used include, but are not limited to polypropylenes, polyethylenes, polyolefins, polystyrenes, polyesters, fluorinated polymers (fluoropolymers), polyamides, polyaramids, acrylonitrile butadiene styrene, nylons, polycarbonates, beta-lactams, block copolymers or any combination thereof. The polymer may be a synthetic (man-made) polymer or a natural polymer. The material used to form the fibers may be a composite of different polymers or a composite of a medicinal agent combined with a polymeric carrier. Specific polymers that may be used include, but are not limited to chitosan, nylon, nylon-6, polybutylene terephthalate (PBT), polyacrylonitrile (PAN), poly(lactic acid) (PLA), poly(lactic-co-glycolic acid) (PLGA), polyglycolic acid (PGA), polyglactin, polycaprolactone (PCL), silk, collagen, poly(methyl methacrylate) (PMMA), polydioxanone, polyphenylene sulfide (PPS); polyethylene terephthalate (PET), polytetrafluoroethylene (PTFE), polyvinylidene fluoride (PVDF), polypropylene (PP), polyethylene oxide (PEO), acrylonitrile butadiene, styrene (ABS), and polyvinylpyrrolidone (PVP).

In another embodiment, the material used to form the fibers may be a metal, ceramic, or carbon-based material. Metals employed in fiber creation include, but are not limited to, bismuth, tin, zinc, silver, gold, nickel, aluminum, or combinations thereof. The material used to form the fibers may be a ceramic such as alumina, titania, silica, zirconia, or combinations thereof. The material used to form the fibers may be a composite of different metals (e.g., an alloy such as nitinol), a metal/ceramic composite or ceramic oxides (e.g., PVP with germanium/palladium/platinum).

The fibers that are created may be, for example, one micron or longer in length. For example, created fibers may be of lengths that range from about 1 μm to about 50 cm, from about 100 μm to about 10 cm, or from about 1 mm to about 1 cm. In some embodiments, the fibers may have a narrow length distribution. For example, the length of the fibers may be between about 1 μm to about 9 ∞m, between about 1 mm to about 9 mm, or between about 1 cm to about 9 cm. In some embodiments, when continuous methods are performed, fibers of up to about 10 meters, up to about 5 meters, or up to about 1 meter in length may be formed.

In certain embodiments, the cross-section of the fiber may be circular, elliptical or rectangular. Other shapes are also possible. The fiber may be a single-lumen fiber or a multi-lumen fiber.

In another embodiment of a method of creating a fiber, the method includes: spinning material to create the fiber; where, as the fiber is being created, the fiber is not subjected to an externally-applied electric field or an externally-applied gas; and the fiber does not fall into a liquid after being created.

Fibers discussed herein are a class of materials that exhibit an aspect ratio of at least 100 or higher. The term “microfiber” refers to fibers that have a minimum diameter in the range of 10 microns to 700 nanometers, or from 5 microns to 800 nanometers, or from 1 micron to 700 nanometers. The term “nanofiber” refers to fibers that have a minimum diameter in the range of 500 nanometers to 1 nanometer; or from 250 nanometers to 10 nanometers, or from 100 nanometers to 20 nanometers.

While typical cross-sections of the fibers are circular or elliptic in nature, they can be formed in other shapes by controlling the shape and size of the openings in a spinneret (described below). Fibers may include a blending of multiple materials. Fibers may also include holes (e.g., lumen or multi-lumen) or pores. Multi-lumen fibers may be achieved by, for example, designing one or more exit openings to possess concentric openings. In certain embodiments, such openings may include split openings (that is, wherein two or more openings are adjacent to each other; or, stated another way, an opening possesses one or more dividers such that two or more smaller openings are made). Such features may be utilized to attain specific physical properties, such as thermal insulation or impact absorbance (resilience). Nanotubes may also be created using methods and apparatuses discussed herein.

Fibers may be analyzed via any means known to those of skill in the art. For example, Scanning Electron Microscopy (SEM) may be used to measure dimensions of a given fiber. For physical and material characterizations, techniques such as differential scanning calorimetry (DSC), thermal analysis (TA) and chromatography may be used.

In one embodiment, microfibers and nanofibers may be produced substantially simultaneously. Any spinneret described herein may be modified such that one or more openings has a diameter and/or shape that produces nanofibers during use, and one or more openings have a diameter and/or shape that produces microfibers during use. Thus, a spinneret, when rotated will eject material to produce both microfibers and nanofibers. In some embodiments, nozzles may be coupled to one or more of the openings. Different nozzles may be coupled to different openings such that the nozzles designed to create microfibers and nozzles designed to create nanofibers are coupled to the openings. In an alternate embodiment, needles may be coupled (either directly to the openings or via a needle port). Different needles may be coupled to different openings such that needles designed to create microfibers and needles designed to create nanofibers are coupled to the openings. Production of microfibers and nanofibers substantially simultaneously may allow a controlled distribution of the fiber size to be achieved, allowing substantial control of the properties of products ultimately produced from the microfiber/nanofiber mixture.

Microfibers and nanofibers produced using any of the devices and methods described herein may be used in a variety of applications. Some general fields of use include, but are not limited to: food, materials, electrical, defense, tissue engineering, biotechnology, medical devices, energy, alternative energy (e.g., solar, wind, nuclear, and hydroelectric energy);

therapeutic medicine, drug delivery (e.g., drug solubility improvement, drug encapsulation, etc.); textiles/fabrics, nonwoven materials, filtration (e.g., air, water, fuel, semiconductor, biomedical, etc); automotive; sports; aeronautics; space; energy transmission; papers; substrates; hygiene; cosmetics; construction; apparel, packaging, geotextiles, thermal and acoustic insulation.

Some products that may be formed using microfibers and/or nanofibers include but are not limited to: filters using charged nanofiber and/or microfiber polymers to clean fluids; catalytic filters using ceramic nanofibers (“NF”); carbon nanotube (“CNT”) infused nanofibers for energy storage; CNT infused/coated NF for electromagnetic shielding; mixed micro and NF for filters and other applications; polyester infused into cotton for denim and other textiles; metallic nanoparticles or other antimicrobial materials infused onto/coated on NF for filters; wound dressing, cell growth substrates or scaffolds; battery separators; charged polymers or other materials for solar energy; NF for use in environmental clean-up; piezoelectric fibers; sutures; chemical sensors; textiles/fabrics that are water & stain resistant, odor resistant, insulating, self-cleaning, penetration resistant, anti-microbial, porous/breathing, tear resistant, and wear resistant; force energy absorbing for personal body protection armor; construction reinforcement materials (e.g., concrete and plastics); carbon fibers; fibers used to toughen outer skins for aerospace applications; tissue engineering substrates utilizing aligned or random fibers; tissue engineering Petri dishes with aligned or random nanofibers; filters used in pharmaceutical manufacturing; filters combining microfiber and nanofiber elements for deep filter functionality; hydrophobic materials such as textiles; selectively absorbent materials such as oil booms; continuous length nanofibers (aspect ratio of more than 1,000 to 1); paints/stains; building products that enhance durability, fire resistance, color retention, porosity, flexibility, anti microbial, bug resistant, air tightness; adhesives; tapes; epoxies; glues; adsorptive materials; diaper media; mattress covers; acoustic materials; and liquid, gas, chemical, or air filters.

Fibers may be coated after formation. In one embodiment, microfibers and/or nanofibers may be coated with a polymeric or metal coating. Polymeric coatings may be formed by spray coating the produced fibers, or any other method known for forming polymeric coatings. Metal coatings may be formed using a metal deposition process (e.g., CVD).

The principal causes of death among soldiers who die within the first hour after injury are hemorrhage and traumatic brain injury. There is a need to develop technologies that could promote early intervention in life-threatening injuries. These new devices/materials must be easily transportable (i.e., compact, lightweight); easy to use, low maintenance, adaptable to different environments and should have self-contained power sources as necessary.

In an embodiment, a hand-held fiber producing device, as described herein, may be used to provide fibers to a wound, to stop hemorrhaging and promote tissue mending. As used herein, a wound is defined as an injury or tear on the skin surface by physical, chemical, mechanical, and/or thermal damages (i.e., a burn). In an embodiment, an appropriate fiber producing material is loaded into a hand-held fiber producing device, as described above. When an injury occurs, the hand-held fiber producing device may be used to apply fibers (e.g., microfibers and/or nanofibers) to the wound site. The fibers applied to the wound site accelerate the stoppage of blood loss and promote tissue healing.

In an embodiment, a solution of an appropriate polymer that is suitable for promoting tissue mending and/or stopping hemorrhaging is placed into a hand-held fiber producing device. The device is operated to produce a stream of fibers that may be directed toward the wound site. The wound site may be a cut, a puncture, or a burn in on the subject. The fibers may form as the solvent evaporates leaving microfibers and/or nanofibers disposed on the wound. In some embodiments, the fibers may be formed from a polymer suitable to absorb a portion of the bodily fluids coming out of the wound site. In another embodiment, the formed fibers coalesce together to form a fine mesh or mat that protects the wound site. For burn sites, a water absorbent polymer may be used to form the fibers to allow a moist water enriched wound dressing for burns.

In another embodiment, a mesh-like material may be paced over the wound. Following application of the mesh-like material, the hand-help fiber producing device may be used to produce fibers, which are directed toward the mesh-like material. The fibers may interact and become embedded within the mesh, forming a customized wound dressing formed of suitable polymers combined with the mesh.

A number of polymers may be used in wound dressing applications. Exemplary polymers include, but are not limited to, polystyrene, poly (3-hydroxyl butyrate-co-poly (3-hydroxyl valerate), polycaprolactone, polyethylene oxide, polyethylene glycol, poly(methyl methacrylate), cellulose acetate, Nylon 6, polyvinyl chloride, gelatin, polyethyleneoxide, polycarbonate, polyurethane, polyacrylonitrile, poly(ethylene terephthalate), poly (ethylene naphthalate), Poly(ethylene-co-vinyl acetate), polylactic acid, dextran, poly-L-lactide, polyvinylcarbazole, poly (vinyl alcohol), chitosan, polybenzimidazole, and poly (glycolic acid). These, and other polymers may be used to form a wound dressing by dissolving and/or suspending the polymer in an appropriate solvent, then placing the mixture into the hand-held fiber producing device to form the appropriate fibers. Suitable solvents include, but are not limited to, acetone, chloroform, dichloromethane, dimethyl formamide, dimethyl sulfoxide, ethanol, formamide, isopropyl alcohol, methanol, tetrahydrofuran, toluene, and water,

Use of the disclosed hand-held fiber producing device allows the formation of microfibers and/or nanofibers for use in wound dressings. Microfibers and/or nanofibers offer a number of advantages over conventional wound dressing materials. Nanofiber wound dressings have small pores and a high effective surface area which promote the hemostasis phase of wound healing. Due to the high surface area to volume ratio of nanofibers and microfibers, hydrophilic polymers formed into microfibers and/or nanofibers exhibit high water absorption (up to about 25% by weight). Hydrophilic polymers are also able to absorb wound exudates more efficiently than the typical film dressings. The porous structure of a microfiber and/or nanofiber dressing made by the disclosed method provides enhanced respiration of underlying wound, which helps to prevent the wound from drying up and will reduce scarring. Finally, being able to direct fibers directly at the wound site allows the wound dressing to be customized for the needs of the patient.

A hand-held fiber device and a solution for forming the fibers for a wound dressing may be bundled into a kit. Such a kit may be used to allow a medical practitioner to apply would dressing outside of an office setting. For example, emergency medical technicians, paramedics, and military field medics can use such a kit to prepare a customized dressing for a would at the site of the incident. The kit may include multiple solutions, each of the solutions capable of forming different polymeric wound dressings.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A hand held/portable device for the production of microfibers and/or nanofibers comprising:
one or more motors,
a fan coupled to at least one of the one or more motors;
a spinneret comprising a body and one or more openings, the spinneret being coupled to at least one of the one or more motors, wherein the fan and spinneret are, during use, rotated substantially simultaneously;
wherein, during use, rotation of the spinneret causes material placed in the body of the spinneret to be ejected through one or more of the openings to produce fibers, and
wherein the fan is positioned with respect to the spinneret such that the fibers produced by the spinneret are blow away from the spinneret by the gas flow produced by the rotating fan.

2. The device of claim 0, further comprising a material reservoir coupled to the body of the spinneret, wherein material disposed in the material reservoir is transferred to the spinneret body during use.

3. The device of claim 0, wherein the motor, fan and spinneret are placed in a molded housing.

4. The device of claim 0, wherein the molded housing comprises a handle.

5. The device of claim 0, wherein the molded housing comprises a tapered outlet, wherein fibers produced by the spinneret are blow away from the spinneret into the tapered outlet.

6. The device of claim 0, wherein the fan, the motor, and the spinneret are aligned along an axial axis of the molded housing.

7. The device of claim 1, wherein the fan and spinneret are positioned on opposing sides of the one or more motors.

8. The device of claim 0, comprising a first motor coupled to the fan and a second motor coupled to the spinneret.

9. The device of claim 0, wherein the first motor rotates the fan at a different speed than the second motor rotates the spinneret during use.

10. The device of claim 0, wherein the spinneret comprises a plurality of outlet elements coupled to the body, wherein one or more openings are formed in the outlet elements, extending through the outlet elements to the , wherein during use, material in the body passes through the openings formed in the outlet elements.

11. The device of claim 0, wherein the spinneret further comprises one or more pellets positioned in the one or more openings, wherein the pellets inhibit the ejection of material from the one or more outlet elements unless the spinneret is rotating.

12. The device of claim 0, further comprising a filter positioned downstream from the fan.

13. The device of claim 0, wherein at least one motor is capable of rotating the spinneret at speeds of greater than about 1000 rpm.

14. The device of claim 0, wherein the spinneret is removably coupled to at least one motor through a coupling member.

15. The device of claim 1, wherein the fibers produced by the spinneret comprise microfibers.

16. The device of claim 1, wherein the fibers produced by the spinneret comprise nanofibers.

17. The device of claim 1, further comprising at least one battery coupled to the one or more motors.

18. The device of claim 1, further comprising a channeling chamber coupled to the housing, wherein the channeling chamber directs the fibers exiting the fiber producing device during use.

19. The device of claim 0, wherein the channeling chamber is coupled to the housing by a hinge, wherein the hinge is configured to allow the channeling chamber to be moved away from the housing during use.

20. A method of producing microfibers and/or nanofibers, comprising:
placing material in a a spinneret of a hand held/portable device, wherein the device comprises:
one or more motors,
a fan coupled to at least one of the one or more motors;
a spinneret comprising a body and one or more openings, the spinneret being coupled to at least one of the one or more motors, wherein the fan and spinneret are, during use, rotated substantially simultaneously;
wherein, during use, rotation of the spinneret causes material placed in the body of the spinneret to be ejected through one or more of the openings to produce fibers, and
wherein the fan is positioned with respect to the spinneret such that the fibers produced by the spinneret are blow away from the spinneret by the gas flow produced by the rotating fan.
rotating the spinneret at a speed of at least about 1000 rpm, and, substantially simultaneously rotating the fan, wherein rotation of the spinneret causes material in the body to be ejected through one or more openings to produce fibers; and wherein the fibers produced by the spinneret are blow away from the spinneret by the gas flow produced by the rotating fan.

21-29. (canceled)
